(19) United States
(12) Patent Application Publication
(10) Pub. No.: US 2025/0338298 A1
(43) Pub. Date: Oct. 30, 2025

(54) Terminal, System, and Method for Allocating Resources in Sidelink Localization Procedure

(71) Applicant: Apple Inc., Cupertino, CA (US)

(72) Inventors: Oghenekome Oteri, San Diego, CA (US); Chunxuan Ye, San Diego, CA (US); Hong He, San Jose, CA (US); Haitong Sun, Saratoga, CA (US); Dawei Zhang, Saratoga, CA (US); Yushu Zhang, Beijing (CN); Wei Zeng, Saratoga, CA (US); Seyed Ali Akbar Fakoorian, San Diego, CA (US); Weidong Yang, San Diego, CA (US)

(21) Appl. No.: 18/861,078

(22) PCT Filed: Apr. 29, 2022
(86) PCT No.: PCT/CN2022/090451

§ 371 Date: Oct. 28, 2024

(51) Int. Cl. H04W 72/40; H04L 5/00; H04W 64/00

(52) U.S. Cl. CPC H04W 72/40; H04L 5/0051; H04W 64/00

(57) ABSTRACT

A first terminal may include a receiver that receives, from a second terminal, configuration parameters for a Sidelink (SL) localization procedure in which positioning information of the first terminal is obtained. Further, the first terminal may include a processor configured to determine, based on the configuration parameters, a resource allocation pattern to be used in an SL transmission procedure. The processor may be also configured to implement the resource allocation pattern in accordance with the SL transmission procedure to obtain the positioning information.

### FIELD

The present application relates to wireless devices and wireless networks, including devices, circuits, and methods for performing Sidelink localization procedures.

### BACKGROUND

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies. Accordingly, improvements in the field in support of such development and design are desired.

### SUMMARY

According to one or more embodiments, a first terminal includes a receiver that receives, from a second terminal, configuration parameters for a Sidelink (SL) localization procedure in which positioning information of the first terminal is obtained. Further, the first terminal includes a processor configured to determine, based on the configuration parameters, a resource allocation pattern to be used in an SL transmission procedure. The processor is also configured to implement the resource allocation pattern in accordance with the SL transmission procedure to obtain the positioning information.

The techniques described herein may be implemented in and/or used with a number of different types of devices, including but not limited to cellular phones, wireless devices, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates an example block diagram of a UE, according to some aspects.

FIG. 3 illustrates an example block diagram of a BS, according to some aspects.

FIG. 4 illustrates an example block diagram of wireless communication circuitry, according to some aspects.

FIG. 5 illustrates an example Sidelink (SL) localization procedure, according to some aspects.

FIG. 6 is a diagram illustrating an example of a slot structure in a radio frame, according to some aspects.

FIGS. 7A to 7C are diagrams illustrating examples of radio frame configurations, according to some aspects.

FIG. 8 is a flowchart detailing a method of allocating resources in an SL localization procedure, according to some aspects.

FIGS. 9A to 9D are diagrams illustrating examples of radio frame configurations, according to some aspects.

FIG. 10 is a flowchart detailing a method of allocating resources in an SL localization procedure, according to some aspects.

FIGS. 11A to 11D are diagrams illustrating examples of radio frame configurations, according to some aspects.

FIG. 12 is a flowchart detailing a method of allocating resources in an SL localization procedure, according to some aspects.

FIGS. 13A and 13B are diagrams illustrating examples of radio frame configurations, according to some aspects.

FIG. 14 is a flowchart detailing a method of allocating resources in an SL localization procedure, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

There is a need to study and evaluate enabling Sidelink (SL) positioning (i.e., localization), signaling and resource allocation in 5G/New Radio (NR) environments. Thus, disclosed herein are various solutions for performing and improving SL localization procedures, including: 1) time domain allocation of SL resource pools; 2) reference signals for sidelink positioning; 3) determination of placement of SL-P(S) RS signals in slots; 4) interaction of SL with other signals (e.g., DMRS, S-SSB, PSCCH, and PT-RS); 5) frequency domain resource allocation of SL resource pools; and 6) multiplexing multiple SL-(S) PRS signals to serve multiple UEs.

In accordance with one or more embodiments, a user equipment (UE) device or terminal communicating with other terminals (other wireless communication devices, network devices, UE devices, and/or Base Station (BS) devices) may perform radio transmissions including localization procedures to obtain positioning information relating to the UE device. The positioning information may be one or more results from measurement operations specifying a location of the UE device with respect to one or more neighboring terminals with a known location on Earth or within a specific area (in a predetermined or estimated area, such as its location in a section of a building).

In some embodiments, a UE device may be configured to coordinate the localization procedures with other terminals using at least one Sidelink (SL) communication link. The UE device or one of the other terminals may use the established SL communication links to calculate the positioning information of the UE device when the UE device is in an area with reduced coverage, or without coverage, from a core network. To calculate the positioning information, data transmissions from the UE device may be configured with specific resources to obtain the positioning information. The UE device may implement multiple resource allocation patterns that optimize allocation of resources in data transmissions performed over the SL communication links. These resource allocation patterns may be modified based on an existing coverage on the UE device, ongoing data transmissions among the neighboring terminals, and other sensing and/or communication procedures. In this disclosure, various of these possible resource allocations are described in detail.

The UE device may be configured to perform one or more SL transmissions as part of an SL transmission procedure. The one or more SL transmissions may be transmissions (or reception of transmissions) following protocols in which the UE device allocates resources for a same reference information and a same synchronization information used across neighboring terminals. In some embodiments, the UE device is configured to use the reference information and the synchronization information to communicate with at least one neighboring terminal. The synchronization information may include communication information relating to allocation of resources for at least one synchronization signal. The terminals involved in an SL localization procedure using the SL transmissions may all share the same synchronization signal. The reference information may include communication information identifying at least one neighboring terminal to the UE device as a positioning reference. The positioning reference may be a neighboring terminal that is configured to obtain its absolute location on Earth or in the specific area.

The UE device may implement the SL localization procedure upon receiving instructions from one of its neighboring terminals or upon receiving approval from one of its neighboring terminals after requesting an initialization of the SL localization procedure. The UE device may coordinate the SL transmissions with terminals connected through multiple radio access technologies (RATs) (i.e., LTE-A, 5G NR, and the upcoming 6G).

In some embodiments, the UE device is configured to perform the SL transmissions without negatively impacting a user's experience. To achieve this, the UE device allocates positioning resources without taking data integrity away from communication resources allocated in a same SL transmission. Successful allocation of resources in the SL transmission may prevent data rate reductions, delay increases, or jitter. In this regard, the UE device obtains communication parameters that define the reference information and the synchronization information for the SL localization procedure. The UE device may use the communication parameters to determine a resource allocation pattern to be used in the SL transmission procedure.

The resource allocation pattern may be determined based on configuration parameters obtained for the SL transmission procedure. In one or more embodiments, the UE device identifies an SL resources pool including a set of SL resources for communicating directly with one or more additional terminals in the SL transmission procedure. The resource allocation pattern may be determined based on the SL resources pool identified and/or may include resources allocated to at least a portion of the set of SL resources in the SL resources pool. The SL resources pool may be an existing SL resources pool previously configured for the SL localization procedure and/or may be an independent SL resources pool selected specifically for the SL localization procedure.

In other embodiments, the UE device identifies an SL reference signal that is used in the SL localization procedure to obtain the positioning information based on the configuration parameters. The resource allocation pattern may be determined based on the SL reference signal identified. The resource allocation pattern may include resources allocated to include the SL reference signal. Examples of the SL reference signal may include an SL-Positioning Reference Signal (PRS) configured to be implemented in a first resource allocation pattern, an SL-Positioning Sounding Reference Signal (PSRS) configured to be implemented in a second resource allocation pattern, or an SL-joint PRS/PSRS (P(S) RS) configured to be implemented in the first resource allocation pattern, the second resource allocation pattern, or a combination of the first resource allocation pattern and the second resource allocation pattern based on terminal information of the UE device.

The UE device may initiate the SL localization procedure by transmitting, to the neighboring terminal, a broadcasting signal, which may include terminal capability and at least one communication request. The terminal capability may be communication information regarding one or more transmission and reception capabilities of the UE device, while the communication request may include a request for a start of the localization procedure to the neighboring terminal.

As described above, the configuration parameters may be received by the UE device from the neighboring terminal via an SL communication link. If the neighboring terminal is another UE device, the configuration parameters may be obtained from the other UE device via additional communication links established with a core network. If the neighboring terminal is a base station, the configuration parameters may be obtained from the base station via higher layer signaling (e.g., signaling received from upper layers using Radio Resource Control (RRC) messaging or medium Access Control (MAC) messaging in devices connected to the core network).

In the SL localization procedure, the UE device may attempt to obtain its positional information upon identifying that the UE has exited an area of coverage from the core network (e.g., the UE device is out of coverage). The UE device may obtain the positional information and its absolute location directly from the neighboring terminal. In some embodiments, the UE device may be configured to derive its absolute location from the positional information obtained from the neighboring terminal. In the SL localization procedure between the neighboring terminal and the UE device, the absolute location of the UE device may be derived based on the absolute location of the neighboring terminal and a location of the UE device with respect to the neighboring terminal. Upon obtaining the absolute location of the neighboring terminal, the neighboring terminal or the UE device may determine relative positioning associated with the UE device. In some embodiments, the neighboring terminal or the UE device may determine the location of the UE device with respect to the neighboring terminal after evaluating one or more signals received or transmitted. In turn, the neighboring terminal or the UE device may calculate the absolute location of the UE device based on the relative positioning.

The following is a glossary of terms that may be used in this disclosure:

Memory Medium—Any of various types of non-transitory memory devices or storage devices. The term “memory medium” is intended to include an installation medium, (e.g., a CD-ROM, floppy disks, or tape device; a computer system memory or random access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAS, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.

Wireless Device—any of various types of computer systems or devices that perform wireless communications. A wireless device may be portable (or mobile) or may be stationary or fixed at a certain location. A UE is an example of a wireless device.

Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.

Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).

Band—The term “band” has the full breadth of its ordinary meaning, and at least includes a section of spectrum (e.g., radio frequency spectrum) in which channels are used or set aside for the same purpose.

Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

### Example Wireless Communication System

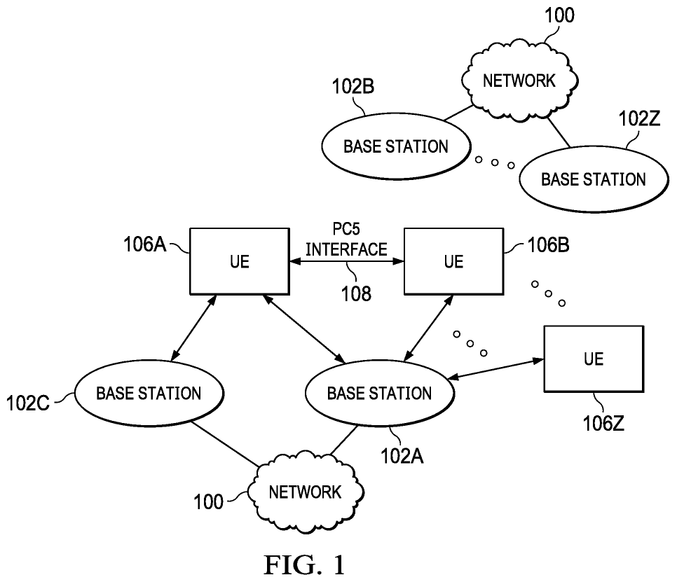

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106Z. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106Z.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using a PC5 interface for direct communications between devices. The IoT UEs may also execute background applications (e.g., keep-alive messages, status updates, and the like) to facilitate the connections of the IoT network.

As shown, the UEs 106, such as UE 106A and UE 106B, may directly exchange communication data via a PC5 interface 108. The PC5 interface 108 may comprise one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (vUEs). The RSU may also include internal data storage circuitry to store intersection map geometry, traffic statistics, media, as well as applications/software to sense and control ongoing vehicular and pedestrian traffic. The RSU may operate on the 5.9 GHz Intelligent Transport Systems (ITS) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weatherproof enclosure suitable for outdoor installation, and may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106Z and similar devices over a geographic area via one or more cellular communication standards.

Thus, while base station 102A may act as a “serving cell” for UEs 106A-106Z as illustrated in FIG. 1, each UE 106 may also be capable of receiving signals from (and possibly within communication range of) one or more other cells (which may be provided by base stations 102B-102Z and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102Z may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

In one or more embodiments, the UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Description of Sidelink (SL) Communication Links

In one or more embodiments, SL communication links are communication links established between terminals acting as UE devices. In SL communication links, each aforementioned physical channels corresponds to a set of resource elements carrying information originating from higher layers. These physical signals may include reference information signaling and synchronization information signaling. The reference information signaling may include reference information identifying at least one terminal a positioning reference using a reference signal (e.g., a demodulation reference signal). The positioning reference may be a terminal that is configured to obtain its absolute location on Earth or location within a specific area. The synchronization information signaling may include synchronization information relating to allocation of resources for at least one synchronization signal.

The reference signal is used to provide multiple terminals with a baseline transmission information that these terminals may identifying on SL transmissions exchanged with one other. As described above, reference signals are predefined signals occupying specific resource elements within a communication time-frequency grid. In the NR specification, multiple types of reference signals may be transmitted in different ways and intended to be used for different purposes by a receiving device. In this disclosure, the reference signals are modified for implementation in SL transmissions.

Examples of synchronization information may include communication information relating to allocation of resources for at least one synchronization signal. A first option for the synchronization signal may be a Demodulation Reference Signal (DMRS) used for the PSSCH. In an Orthogonal Frequency Division Multiplexing (OFDM) symbol for the PSSCH, the synchronization signal may be the associated DMRS. A second option for the synchronization signal may be a DMRS for Demodulation Reference Signal (DMRS) used for the PSSCH. A third option for the synchronization signal may be a Phase Tracking Reference Signal (PTRS) configured to track phase changes and compensate phase noise during SL transmissions, which may be used for higher carrier frequencies. A time density and a frequency of the PTRS may be configured by the upper layers and may be configured per resource pool. A fourth option for the synchronization signal may be a Channel-State Information Reference Signal (CSI-RS). The CSI-RS may be used for channel sounding. The receiving device may measure the received CSI-RS, then may report back the CSI to the transmitter via the PSSCH. The CSI-RS may be configurable in both the time domain and frequency domain. The CSI-RS may be used to provide fine channel state information. A fifth option for the synchronization signal may be a Synchronization Signal (SS)/PSBCH Block. A slot that transmits the SS/PSBCH block may be referred to as a Sidelink Synchronization Signal Block (S-SSB). The SS/PSBCH block may include PSBCH, Sidelink Primary Synchronization Signal (SPSS) and Sidelink Secondary Synchronization Signal (SSSS) symbols. The period of the S-SSB transmission may be 16 frames, and within each period, the number of S-SSB blocks N in the S-SSB period is configured at the RRC. The range of choices for N may vary based on the numerology and the frequency range.

In one or more embodiments, the UE devices are configured to handle simultaneous sidelink and uplink/downlink transmissions. If any of the UE devices include limited reception capabilities in comparison to the rest of the UE devices, this UE device may prioritize sidelink communication reception, sidelink discovery reception on carriers configured by the eNodeB, and last sidelink discovery reception on carriers not configured by the gNB.

Sidelink transmissions may be organized into radio frames with a duration of T_{f}, each consisting of 20 slots of duration Tₛₗₒₜ. A sidelink subframe consists of two consecutive slots, starting with an even-numbered slot. A transmitted physical channel or signaling in a slot may be described by a resource grid corresponding to a first number of subcarriers and a second number of Single-Carrier (SC)-Frequency Division Multiple Access (FDMA) symbols.

In some embodiments, SL transmissions may be configured in accordance with a resource allocation pattern provided by the gNB. The resource allocation pattern may provide dynamic grants of sidelink resources, as well as grants of periodic sidelink resources configured semi-statically by sidelink configured grants. To improve a reliability of the SL transmissions, a dynamic sidelink grant DCI may provide resources for one or multiple transmissions of a transport block. The sidelink configured grants may be SL transmissions configured to be used by the UE device immediately, until these grants are released by RRC signaling. The UE device may be allowed to continue using this type of sidelink configured grants when beam failure or physical layer problems occur in NR access links (Uu) until a Radio Link Failure (RLF) detection timer expires, before falling back to an exception resource pool. Another type of sidelink configured grant may be a grant that is configured once and may not be used until the gNB sends the UE device a DCI indicating that the grant is now active, and until another DCI indicates deactivation.

In the sidelink configured grants, the resources are a set of sidelink resources recurring with a periodicity which the gNB matches resourced to those characterize for V2X traffic. Multiple configured grants can be configured, to allow provision for different services, traffic types, and the like. Modulation and Coding Scheme (MCS) information for dynamic and configured grants may be optionally provided or constrained by the RRC signaling instead of the DCI. The RRC may configure exact MCS the uses, or a range of MCSs. The MCS may also be left unconfigured. For the cases where the RRC does not provide the exact MCS, the UE device may be left to select an appropriate MCS itself based on any knowledge it may have of the transport block to be transmitted and sidelink radio conditions. The gNB scheduling activity may be driven by reporting in which the UE device shares its sidelink traffic characteristics to the gNB, or by performing a sidelink Buffer Status Report (BSR) procedure similar to that of the Uu to request the sidelink resource allocation from the gNB.

In some embodiments, the SL transmissions for the UE device may be configured in accordance with a self-selected resource allocation pattern. The SL transmissions may be transmitted by the UE device a certain number of times after a resource allocation pattern is selected, or until a cause of resource reselection is triggered. The SL transmissions may be performed to support unicast and groupcast communications in the physical layer. The SL transmissions may be configured to reserve resources to be used for a number of blind transmissions or HARQ-feedback-based transmissions of the transport block. The SL transmissions may be performed to select resources to be used for the initial transmission of a later transport block.

In one or more embodiments, the resource allocation patterns selected for the SL transmissions may be implemented in SL Bandwidth Parts (BWP). SL BWP may be sets oof contiguous resource blocks configured for the SL transmissions inside a predetermined channel bandwidth. The configuration of the SL BWP and resource pools is established by the RRC layer and provided to lower layers when activated. There may be at least one active SL BWP for the UE device at a time in a given frequency band. The SL BWP may be defined by its frequency, bandwidth, Subcarrier Spacing (SCS), and Cyclic Prefix (CP). The SL BWP may define parameters common to all the resource pools that are contained within it, namely a number of symbols and starting symbol used for SL in all slots (except those with Synchronization Signal Block (SSB)), power control for PSBCH, and a location of a Direct Current (DC) subcarrier.

The SL BWP may have different lists of resource pools for transmissions and receptions, to allow for the UE device to transmit in a pool and receive in another one. For transmissions, there may be one pool for a selected mode, one for a scheduled mode (e.g., when the gNodeB helps with resource selection), and one for exceptional situations. These resource pools may be expected to be used for only transmission or reception, except when SL feedback mechanisms are activated, in which case the UE device may transmit Acknowledgement (ACK) messages in a reception pool and receive ACK messages in a transmission pool.

In 5G NR technologies, the resource pool may be located inside an SL BWP is defined by a set of contiguous Resource Blocks (RBs) defined by the information element labeled sl-Rb-Number in the frequency domain starting at an RB defined by the information element labeled sl-StartRBsubchannel. Further, the resource pool may be divided into sub-channels of a size defined by the information element labeled sl-SubchannelSize, which can take one of multiple values (i.e., 10, 12, 15, 20, 25, 50, 75, and 100). Depending on the value of sl-RB-Number and sl-SubchannelSize, some RBs inside the resource pool may not be used by the UEs.

In the time domain, a resource pool has some available slots configured by various parameters. To determine which slots belong to the pool, a series of criteria may be applied. The slots where SSB is transmitted may not be used. The number and locations of those slots may be based on a predefined configuration. Slots that are not allocated for UL (e.g., in the case of Time Division Multiplexing (TDD)) or do not have all the symbols available (as per SL BWP configuration) may also be excluded from the resource pool. Some slots may be reserved such that a number of remaining slots is a multiple of a bitmap length defined by the labels sl-TimeResource-r16 or Lbitmap, that can range from 10 bits to 160 bits. The reserved slots may be spread throughout a variable number of slots. The bitmap sl-TimeResource-r16 may be applied to the remaining slots to compute a final set of identified/labeled slots that belong to the pool.

In some embodiments, the duration of each SL frame and SL subframe is 10 milliseconds (ms) and 1 ms, respectively. The SL frames and SL subframes may include a numerology u which may define the SCS, a number of slots in a subframe, and cyclic prefix options. In NR SL, the value of u ranges from 0 to 3. In addition, the supported u values vary at different frequency bands. In the frequency domain, the SCS may be defined by the numerology. In this regard, the SCS may be directly proportional to the numerology. Within the SL subframe, slots may be numbered from 0 to N subframe. In NR, given that different UE devices may operate in a different BWP and using a different numerology, a common resource block may be used for a device to locate frequency resources within the carrier bandwidth.

### Example Communication Device

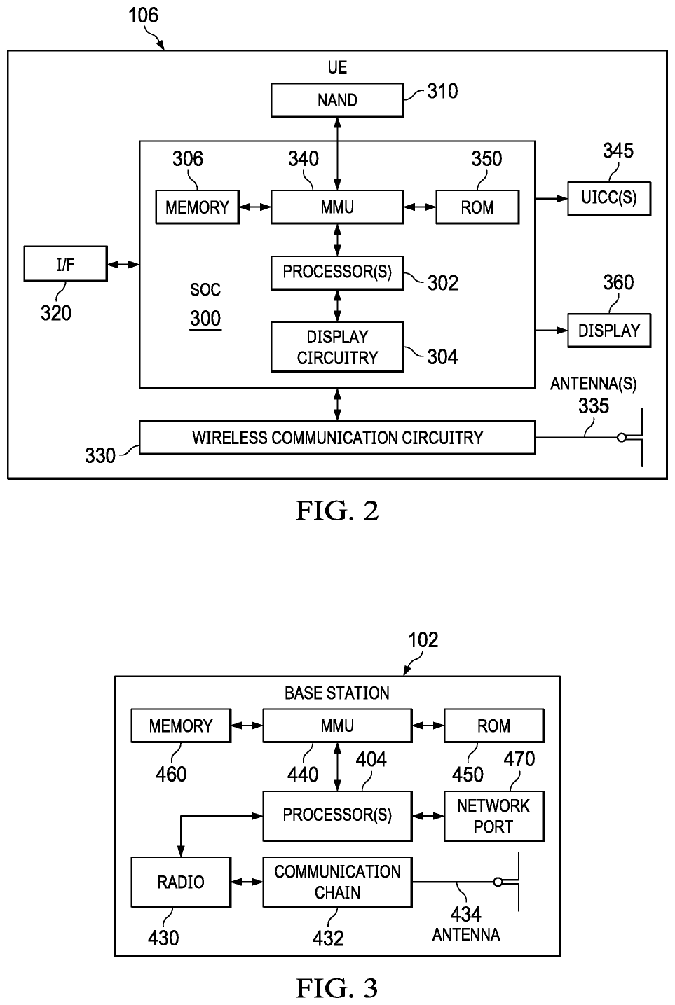

FIG. 2 illustrates an example simplified block diagram of a communication device 106, according to some aspects. It is noted that the block diagram of the communication device of FIG. 2 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; and the like), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 330 may couple (e.g., communicatively; directly or indirectly) to one or more antennas, such as antenna(s) 335 as shown. The wireless communication circuitry 330 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 330 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements.

The communication device 106 may further include one or more smart cards 345 that include Subscriber Identity Module (SIM) functionality, such as one or more Universal Integrated Circuit Card(s) (UICC(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein (e.g., by executing program instructions stored on a memory medium). Alternatively (or in addition), processor 302 may be configured as a programmable hardware element, such as a Field Programmable Gate Array (FPGA), or as an Application Specific Integrated Circuit (ASIC). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, and the like) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, and the like) configured to perform the functions of wireless communication circuitry 330.

### Example Base Station

FIG. 3 illustrates an example block diagram of a base station 102, according to some aspects. It is noted that the base station of FIG. 3 is a non-limiting example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIG. 1.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, (e.g., a 5G New Radio (5G NR) base station, or “gNB”). In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including 5G NR, LTE, LTE-A, GSM, UMTS, CDMA2000, Wi-Fi, and the like.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mmWave, the 5G NR radio may be coupled to one or more mmWave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 102 may include hardware and software components for implementing or supporting implementation of features described herein. The processor 404 of the base station 102 may be configured to implement or support implementation of part or all of the methods described herein (e.g., by executing program instructions stored on a memory medium). Alternatively, the processor 404 may be configured as a programmable hardware element, such as a Field Programmable Gate Array (FPGA), or as an Application Specific Integrated Circuit (ASIC), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, and the like) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, and the like) configured to perform the functions of radio 430.

### Example Cellular Communication Circuitry

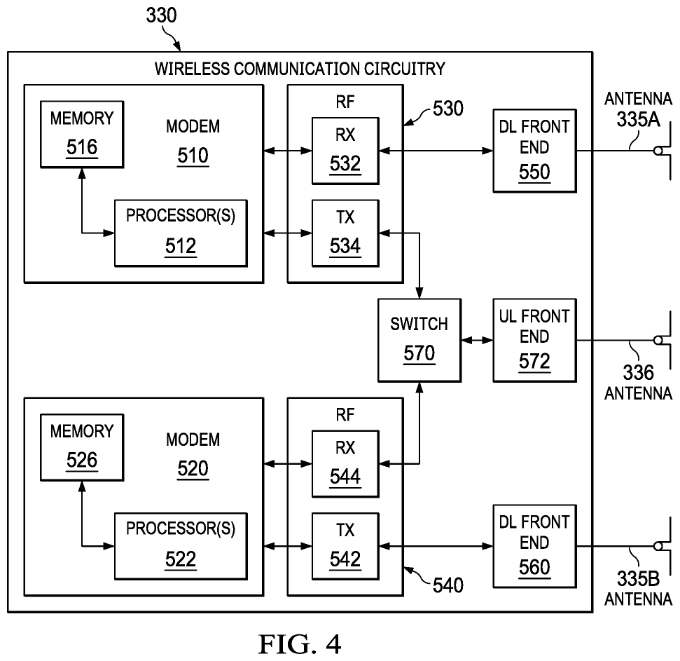

FIG. 4 illustrates an example simplified block diagram of cellular communication circuitry, according to some aspects. It is noted that the block diagram of the cellular communication circuitry of FIG. 4 is only one example of a possible cellular communication circuit; other circuits, such as circuits including or coupled to sufficient antennas for different RATs to perform uplink activities using separate antennas, or circuits including or coupled to fewer antennas (e.g., that may be shared among multiple RATs) are also possible. According to some aspects, cellular communication circuitry 330 may be included in a communication device, such as communication device 106 described above. As noted above, communication device 106 may be a UE device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a, 335b, and 336 as shown. In some aspects, cellular communication circuitry 330 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 4, cellular communication circuitry 330 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some aspects, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some aspects, receive circuitry 542 may be in communication with DL front end 560, which may include circuitry for receiving radio signals via antenna 335b.

In some aspects, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium). Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more processing elements. Thus, processors 512, 522 may include one or more integrated circuits (ICs) that are configured to perform the functions of processors 512, 522. In addition, each integrated circuit may include circuitry (e.g., first circuitry, second circuitry, and the like) configured to perform the functions of processors 512, 522.

In some aspects, the cellular communication circuitry 330 may include only one transmit/receive chain. For example, the cellular communication circuitry 330 may not include the modem 520, the RF front end 540, the DL front end 560, and/or the antenna 335b. As another example, the cellular communication circuitry 330 may not include the modem 510, the RF front end 530, the DL front end 550, and/or the antenna 335a. In some aspects, the cellular communication circuitry 330 may also not include the switch 570, and the RF front end 530 or the RF front end 540 may be in communication, e.g., directly, with the UL front end 572.

### Example SL Communication Link Management

SL communication links may be used to help reduce interference and to help support a large number of wireless devices that are neighboring one another. The SL communication links effectively allows transmission and reception of SL transmissions. In some embodiments, the beams are representations of communication being shared between two wireless devices. These SL transmissions may be directed by each wireless device. In some embodiments, the SL transmissions with a predetermined direction may be referred to as beams. As the beams are directed toward a relatively small area as compared to a cell wide signal, a wireless node needs to know where a wireless device is located relative to the wireless node to allow the wireless node to direct beams toward the wireless device.

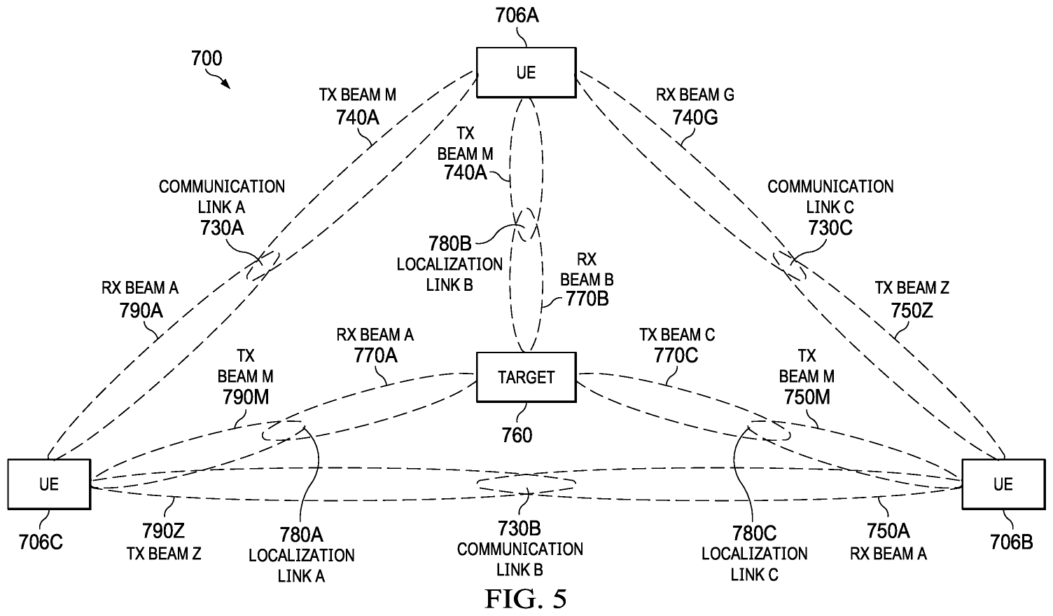

FIG. 5 shows a diagram 500 illustrating multiple SL communication links established to perform multiple SL transmissions. The SL transmissions may be used to implement an SL localization procedure with the goal of obtaining positioning information for a target 760. FIG. 5 shows wireless elements with multi-cell interference equipped with array antennas and capable of establishing multiple SL communication links. The arrays in these wireless elements may be used both for sensing and high-rate low-latency communication.

In the diagram 700 of FIG. 5, the target 760 may request to identify its location using the SL transmissions in coordination with the UE 706A, the UE 706B and the UE 706C. As described above, the SL transmissions may be coordinated to include a resource allocation pattern configured for SL transmissions. In this example, the UE 706C may include beams A 790A . . . 790Z (collectively 790) configured to exchange SL transmissions. The target 760 may be a wireless device or terminal, such as a UE device with an unknown location. In one or more embodiments, the target 760 may request permissions for exchanging SL transmission with the UE 706A, the UE 706B, and UE 706C. The permissions may be acknowledged through SL transmissions. In this case, the permissions may be required to confirm that resource allocation patterns are being coordinated among multiple SL transmissions. For example, to transmit the SL transmission in a licensed band, the terminal may need to confirm with a base station connected to the network that the licensed band has the space to perform the SL transmission using the requested resource allocation pattern. Similarly, to transmit the SL transmission in the licensed band, the terminal may need to confirm with the base station connected to the network that the power level of the SL transmission is at or below permitted safety/interference thresholds.

In some embodiments, the UE 706C may selectively use certain beams for receiving or transmitting SL transmissions. In the example shown in FIG. 5, the UE 706C may use the transmit beam A 790A and transmit beam Z 790Z for transmitting SL transmissions. The UE 706C may use the receive beam M 790M for receiving SL transmissions. The UE 706C may establish communication link A 730A and communication link B 730B with the UE 706A and the UE 706B, respectively. These communication links may be used by the UE 706C to exchange instructions with the UE 706A and the UE 706B for identifying the location of the target 760. In each communication link, the UE 706A and the UE 706B may provide information to the UE 706C regarding sensing feedback to obtain the positioning information. In this regard, the UE 706A uses transmit beam A 740A and transmit beam M 740M to provide SL transmissions to the UE 706C and the target 760, respectively. The UE 706A may use the receive beam G 840G for receiving SL transmissions from the UE 706B. The UE 706A may establish the communication link A 730A and a communication link C 730C with the UE 706C and the UE 706B, respectively. Finally, the UE 706B uses transmit beam M 750M and transmit beam Z 750Z to provide SL transmissions to the target 760 and the UE 706A, respectively. The UE 706B may use the receive beam A 750A for receiving SL transmissions from the UE 706C. The UE 706B may establish the communication link B 730B and the communication link C 730C with the UE 706C and the UE 706B, respectively.

In the example of FIG. 5, the target 760 uses transmit beam A 770A to provide SL transmissions to the UE 706C. Further, the target 760 uses receive beam B 770B and receive beam C 770C to receive SL transmissions from the UE 706A and the UE 706B. The target 760 may establish a localization link A 780A, a localization link B 780B, and a localization link C 780C with the UE 706C, the UE 706A, and the UE 706B. These localization links may be used by the UE 706C, the UE 706A, and the UE 706B to sense (e.g., identifying) the relative positioning information of the target 760.

In some embodiments, a terminal (e.g., the target 760 described in reference to FIG. 5) performing SL transmissions may be configured to allocate sensing resources in communications with one or more neighboring terminals. The terminal may allocate the resources for the SL transmission based on a terminal capability (i.e., parameters such as UE-Capability) preconfigured in the target 760 and/or based on a terminal capability provided from a higher layer signaling obtained from a device connected directly to a network (i.e., a network gateway or a base station if the terminal is a UE device). In some embodiments, the terminal confirms a resource allocation pattern with another terminal expected to receive the SL transmission before the transmission is performed. The terminal capability may indicate resource allocation support information for the terminal.

In one or more embodiments, the terminal performs the SL transmission to perform an SL localization procedure to obtain positioning information relating to the terminal. The terminal or one of the neighboring terminals may use the SL transmissions to identify or request relative positioning information of a target device. The relative positioning information may include a location and/or a distance of the target device with respect to one of the neighboring terminals. The relative positioning information may include the known locations (e.g., absolute locations) of one or more neighboring terminals. For example, relative positioning information may be obtained by the target device and may include a location of the target device with respect to three different neighboring terminals. The information may also include an absolute location for at least one of the neighboring terminals. Upon receiving the relative positioning information, the target device may calculate its exact location (e.g., a three-dimensional position) with respect to one of the neighboring signals that provided an absolute location. Then, the target device may calculate its absolute location based on the absolute location of the neighboring terminal and the location of the target device with respect to the neighboring terminal.

In one or more embodiments, two UE devices communicating with one another may exchange SL transmissions using the SL communication link. The SL communication link may be defined for 5G NR in section 6.3.8 TS 36.331 of the 3GPP standard.

In some embodiments, a base station performing the functionality and having the structure described in reference to the base station 102 of FIGS. 1 and 3 may be used to calculate the positioning information instead of one of the UE devices.

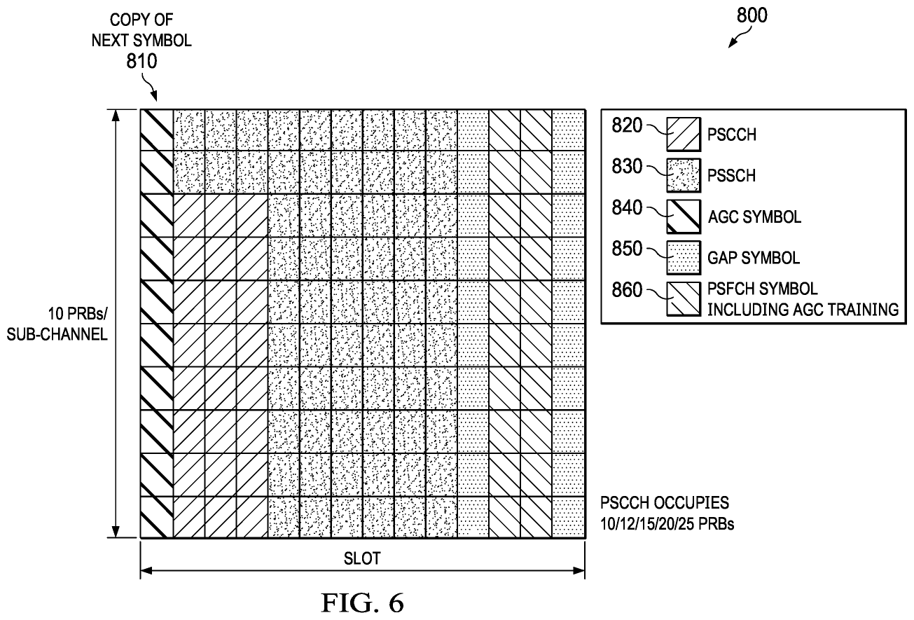

FIG. 6 illustrates diagram 800 showing a slot structure of a radio frame in an SL transmission, in accordance with aspects of the present disclosure. In the examples of FIG. 6, five different types of resources are identified and positioned on the slot. The resources are allocated in a predetermined pattern including 10 PRBs/sub-channels. This predetermined pattern may be a configuration for implementing SL transmissions in 5G NR. The predetermined pattern includes resources allocated for a PSCCH 820, a PSSCH 830, an automatic gain control (AGC) symbol 840, a GAP symbol 850, and a PSFCH symbol 860 including AGC training. In the slot, the AGC symbol 840 is a copy of a next symbol 810. The AGC symbol 840 is used in the slot to automatically control an increase in an amplitude of the radio frame.

In the slot, the AGC symbol 840 may be a first symbol in a slot for AGC training and a first sidelink symbol in a slot is a copy of second sidelink symbol 810. The PSCCH 820 may be a channel configured for sidelink control information. The PSCCH 820 may include an SCI stage 1 with information related to resource allocation in a first stage SCI A type as defined in TS 38.214 of the 3GPP standard. The PSCCH 820 may start from the second symbol in the slot and may last 2 or 3 symbols in the time domain. The PSCCH 820 may be pre-configured or dynamically assigned. The PSCCH 820 may occupy several contiguous PRBs in the frequency domain. The PSCCH 820 may be configured with candidate numbers including 10, 12, 15, 20, or 25 PRBs. The lowest PRB of the PSCCH 820 is the same as a lowest PRB of the corresponding PSSCH 830. The PSSCH 830 may be configured for sidelink data. The PSSCH 830 may be configured to include a second stage SCI information about data transmission and feedback in SCI 2-A (e.g., unicast, groupcast, broadcast) and SCI 2-B (e.g., Groupcast) as defined in TS 38.214 of the 3GPP standard. The GAP symbol 850 may be a symbol used for GAP (i.e., Tx/Rx switch) right after a PSSCH transmission. The PSFCH symbol 860 may be configured for sidelink HARQ feedback. The slot may include a PSBCH that may be configured for sidelink broadcast information and an S-SSB for synchronization.

In some embodiments, the slot is included in an SL BWP. The slot may be part of a resource pool including a set of time-frequency resources for SL transmission and/or reception. The slot may be used in SL transmissions involving unicast, groupcast, and broadcast for a given UE device.

In 5G NR, the PSCCH and the PSBCH may include a DMRS reused for resource mapping and sequencing. Sidelink CSI-RS may be refined in the PSSCH. The sidelink CSI-RS configuration may be given by a PC5 interface, from the UE device transmitting the sidelink CSI-RS. Sidelink PTRS may be refined in the PSSCH. Further, in 5G NR, a UE device may be configured with one or more reference signal information elements, such as those described in TS 38.211, TS 38.214, and TS 38.331 of the 3GPP standard.

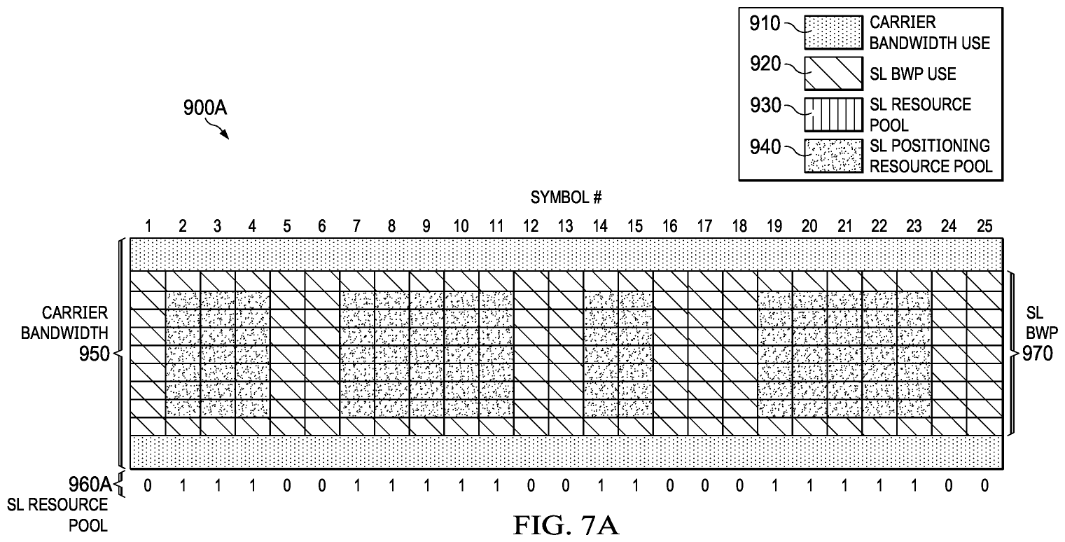

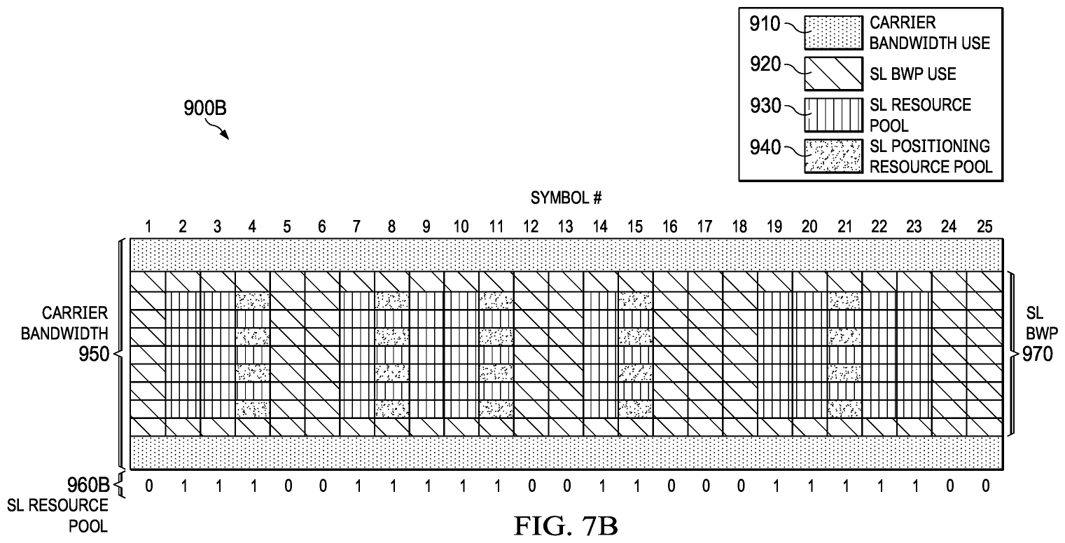

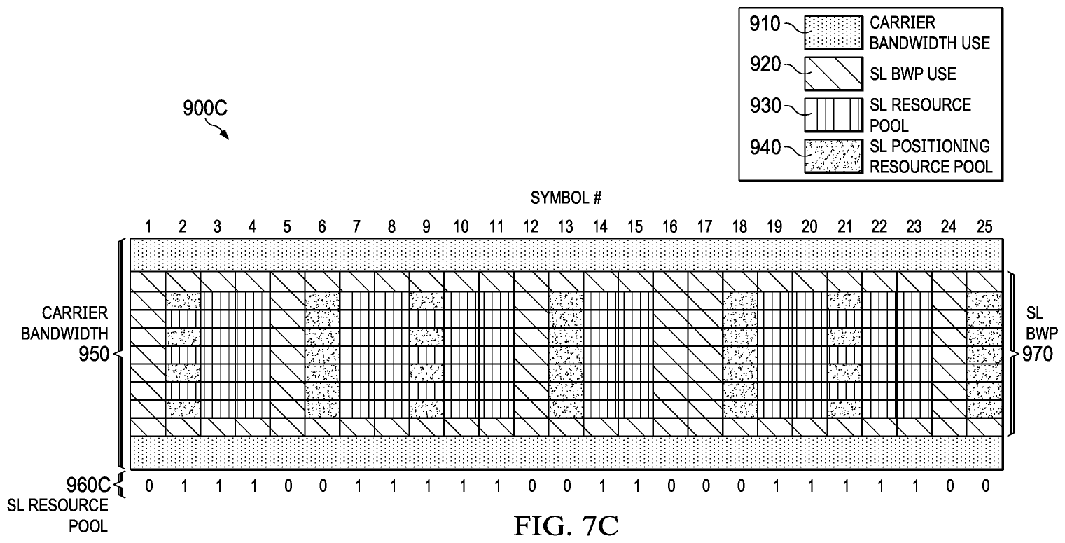

FIGS. 7A-7C illustrate diagrams 900A-900C showing slot structures of a radio frame configured for a resource allocation pattern, in accordance with aspects of the present disclosure. The diagrams 900A-900C show time domain allocation of resources using one or more resource pools. In the examples of FIGS. 7A-7C, slots are shown in a carrier bandwidth 950. The carrier bandwidth 950 includes an SL BWP 970 expanding in a frequency domain in a vertical direction and a time domain in a horizontal direction. In the diagrams 900A-900C, there are 25 symbols in the time domain configured in accordance with a first SL resource pool 960A, a second SL resource pool 960B, and a third SL resource pool 960C, respectively. In the SL resource pools, bits assigned with a zero “0” indicate that a resource is unused (e.g., unallocated) and bits assigned with a one “1” indicate that a resource is used (e.g., allocated). In the examples of FIGS. 7A-7C, the resources may be allocated for carrier bandwidth use 910, SL BWP use 920, an SL resource pool 930, and/or an SL positioning resource pool 940.

In the examples shown in FIGS. 7A-7C, multiple resource allocation patterns are shown for SL transmissions in NR V2X. In NR V2X, certain slots may be pre-configured to accommodate the SL transmissions. These pre-configurations may be “resource pool” consisting of contiguous PRBs and contiguous or non-contiguous slots that have been pre-configured for SL transmissions and defined within the SL BWP 970 with a bitmap of size X.

In FIG. 7A, diagram 900A includes the SL positioning resource pool 940 with slots configured for SL positioning using a set of previously configured slots (e.g., with no additional signaling added) in the SL resource pool 960A.

In FIG. 7B, diagram 900B includes the SL positioning resource pool 940 with slots configured for SL positioning using a portion of a set of previously configured slots in the SL resource pool 960B. In some embodiments, the SL BWP 970 includes the bitmap of size X with bits assigned with “1” in SL positioning slots and bits assigned with “0” in non-SL positioning slots. In the example of FIG. 7B, the bit sequence representative of the SL positioning resource pool 940 is equal to {0, 0, 0, 1, 0, 0, 0, 1, 0, 0, 1, 0, 0, 0, 1, 0, 0, 0, 0, 0, 1, 0, 0, 0, 0}, such that only resources in symbols numbered 4, 8, 11, 15, and 21 are used while any other symbols are left to be allocated to different signals. In some embodiments, the SL BWP 970 includes a bitmap of size Y<X, where Y is equal to a length of the SL transmissions but with assigned “1” in the SL positioning slot and assigned “0” in non-SL positioning slots. In the example of FIG. 7B, a bit sequence representative of a portion of the SL positioning resource pool 940 between slot 4 and 21 may be is equal to {1, 0, 0, 0, 1, 0, 0, 1, 0, 0, 0, 1, 0, 0, 0, 0, 0, 1}, such that only resources in symbols numbered 1, 5, 8, 12, and 18 are used while any other symbols are left to be allocated to different signals.

In FIG. 7C, diagram 900C includes the SL positioning resource pool 940 with slots configured for SL positioning using a portion of a set of newly configured slots in the SL resource pool 960C. In some embodiments, the SL BWP 970 includes resources allocated independently to accommodate the SL positioning slots instead of using the allocation provided for the existing configuration in the SL resource pool 960C. In the example of FIG. 7C, the bit sequence representative of the SL positioning resource pool 940 is equal to {0, 1, 0, 0, 0, 1, 0, 0, 1, 0, 0, 0, 1, 0, 0, 0, 0, 1, 0, 0, 1, 0, 0, 0, 1}, such that only resources in symbols numbered 2, 6, 9, 13, 18, 21, and 25 are used while any other symbols are left to be allocated to different signals.

For the resource allocation patterns in FIGS. 7A-7C, a configuration of SL-PRS resources configuration (with parameters such as SL-PRS-Periodicity, SL-PRS-ResourceRepetition Factor, SL-PRS-ResourceTimeGap, and SL-PRS-ResourceSetSlotOffset) may match a positioning resource pool configuration if the SL-PRS used. Further, aperiodic/periodic or semi-persistent SL-PSRS configurations may match the positioning resource pool if the SL-PSRS used. Finally, the bitmap may be modified to indicate a bit per a number of slots.

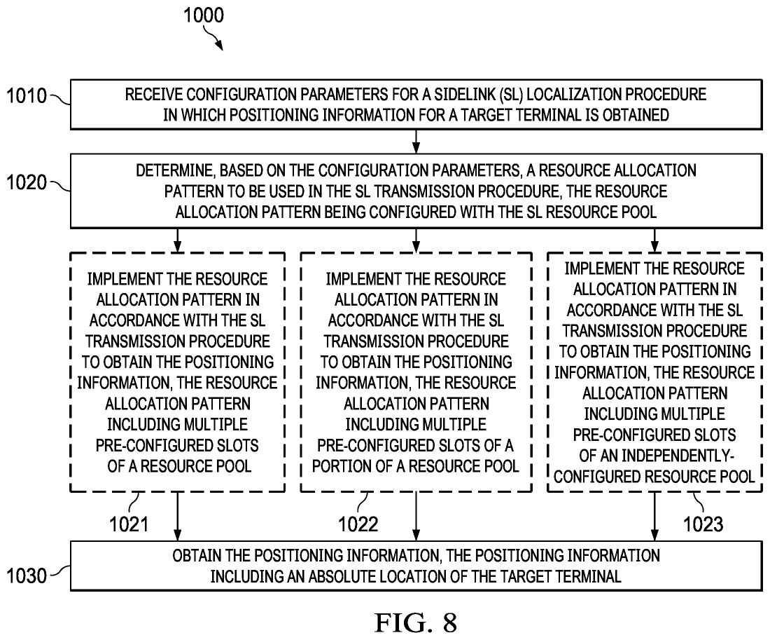

Turning to FIG. 8, a flowchart 1000 is shown, detailing a method of allocating resources in an SL radio frame to be used for an SL localization procedure in accordance with one or more embodiments. In this example, the method is executed by a first terminal exchanging information via SL communication links established with a base station and/or one or more neighboring terminals.

At 1010, the flowchart begins with the first terminal receiving, from a second terminal, configuration parameters for an SL localization procedure in which positioning information is obtained. The localization procedure may be an operation followed by the first terminal in coordination with one or more additional terminals. The additional terminals may be one or more UE devices or a combination of base stations and UE devices. In some embodiments, the first terminal may be a target terminal with an unknown absolute location on Earth on in a specific area (e.g., an area with known boundaries). In some embodiments, the first terminal may be configured to transmit a broadcasting signal to the second terminal. The broadcasting information may include terminal information and a communication request configured to trigger or request triggering of the SL localization procedure. The terminal information is information regarding one or more transmission and reception capabilities of the first terminal.

At 1020, the flowchart continues with the first terminal determining, based on the configuration parameters, a resource allocation pattern to be used in the SL transmission procedure. The resource allocation pattern is configured with an SL resource pool. The resource pool is a combination of contiguous PRBs and contiguous or non-contiguous slots that have been configured for the SL transmission in the manner described in reference to FIGS. 7A-7C. The resource allocation pattern may be determined upon identifying reference information and synchronization information to be used in an SL transmission procedure to obtain the positioning information. The reference information may include communication information identifying at least one neighboring terminal to the first terminal as a positioning reference. The positioning reference may be a neighboring terminal that is configured to obtain its absolute location on Earth or on a specific area. The first terminal may implement the SL localization procedure upon receiving instructions from one of its neighboring terminals. The synchronization information may include communication information relating to allocation of resources for at least one synchronization signal. The terminals involved in an SL localization procedure using the SL transmissions may all share the same synchronization signal.

In 1021-1023, multiple dotted boxed include possible implementations of allocated resources in a resource pattern in which a resource pool is used. At 1021-1023, the resource allocation pattern is implemented in accordance with the SL transmission procedure to obtain the absolute location of the first terminal in the manner described in reference to FIGS. 7A-7C. At 1021, the resource allocation pattern includes multiple pre-configured slots of a resource pool. At 1022, the resource allocation pattern includes multiple pre-configured slots of a portion of a resource pool. At 1023, the resource allocation pattern includes multiple pre-configured slots of an independently-configured resource pool.

The flowchart ends at 1030 with the first terminal obtaining the positioning information. The positioning information includes an absolute location of the target terminal. As described above, the positioning information may include the absolute location of the first terminal or a relative location of the first terminal with respect to the second terminal. If the first terminal determines its own absolute location, the first terminal may store its location. If the second terminal determines the absolute location of the first terminal, the first terminal obtains this information by receiving a communication from the second terminal.

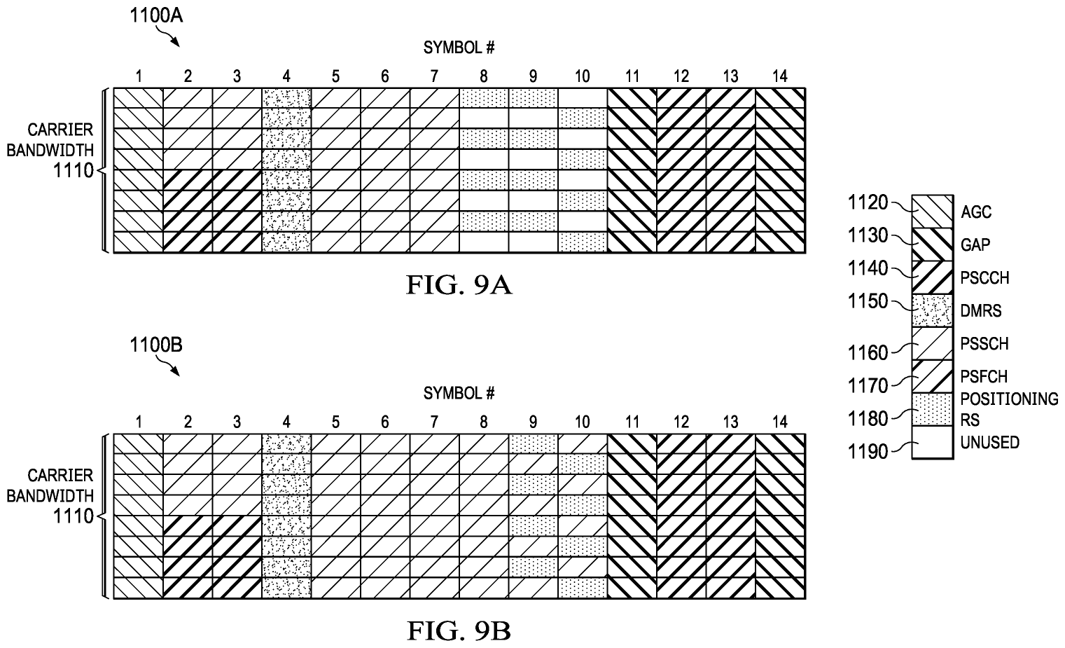

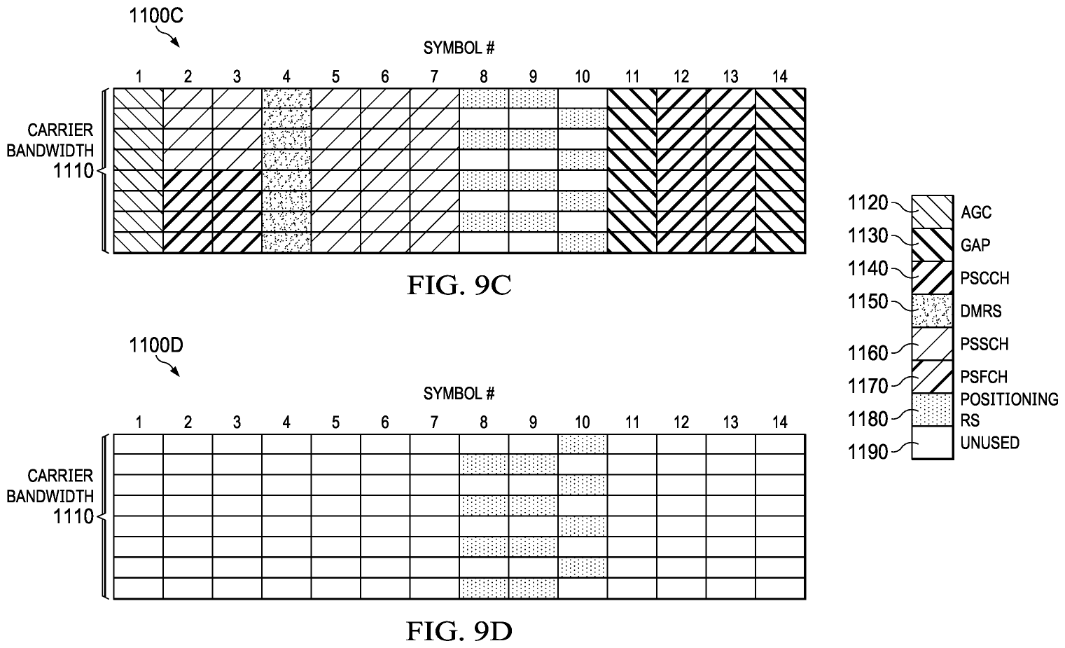

FIGS. 9A to 9D illustrates diagrams 1100A-1100D showing slot structures in a radio frame configured for a resource allocation pattern, in accordance with aspects of the present disclosure. The diagrams 1100A-1100D show multiplexing of multiple reference signals in SL transmissions. In the examples of FIGS. 9A-9D, slots are shown in a carrier bandwidth 1110. The carrier bandwidth 1110 includes an SL BWP expanding in a frequency domain in a vertical direction and a time domain in a horizontal direction. In the examples of FIGS. 9A-9D, the resources may be allocated for an AGC 1120, a GAP 1130, a PSCCH 1140, a DMRS 1150, a PSSCH 1160, a PSFCH 1170, and a positioning RS 1180. The rest of resources may be unused resources 1190.

In the examples shown in FIGS. 9A-9D, given that the SL-PRS/SL-PSRS is structured as a comb in the 5G NR, the Uu link and/or other TRPs may be allocated to unused resources 1190.

In FIG. 9A, unused resources 1190 are left unused as shown in symbol numbers 8-10. In FIG. 9B, unused resources 1190 are used to allocate resources for the PSSCH 1160. In FIG. 9C, unused resources 1190 are used to allocate resources for a second transmission and reception pair (e.g., a bandwidth pair). In this case, the unused resources 1190 may be used to allocate resources to obtain additional positioning information in the SL localization procedure (e.g., incoming SL-Time Difference of Arrival (TDOA) or SL-Angle of Departure (AoD) estimation). In some embodiments, TDOA localization procedures are based on a time delay of arrival to (or from) a target terminal based on 2 or more neighboring terminals in a positioning set. In AoD localization procedures, angles at which SL transmissions departure from neighboring terminals to a target terminal are measured. These angles are then associated with reference signal measurements for each SL transmission to obtain the absolute location of the target terminal. In FIG. 9D, for SL-PSRS, additional SL-TX UE RX UE pairs may transmit the unused resources 1190 in a same resource as it is a Zadoff-Chu (ZC) sequence, as defined by TS 36.211 of the 3GPP standard. In some embodiments, the resource allocation patterns may be modified in accordance with a SL mode 1 or a SL mode 2, as defined by TR 37.985 of the 3GPP standard.

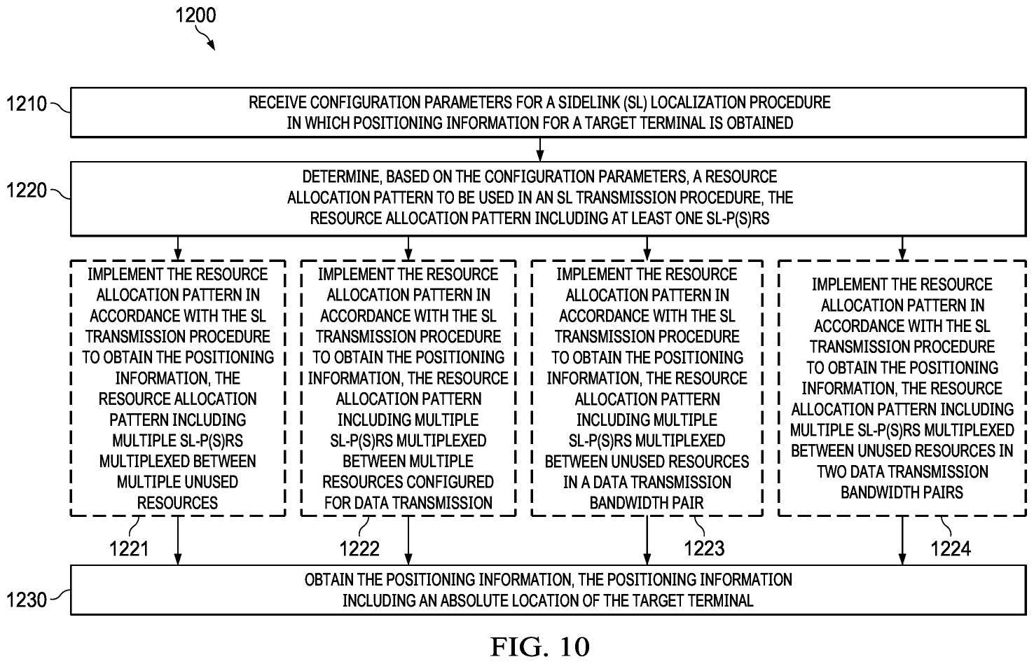

Turning to FIG. 10, a flowchart 1200 is shown, detailing a method of allocating resources in an SL radio frame to be used for an SL localization procedure in accordance with one or more embodiments. In this example, the method is executed by a first terminal exchanging information via SL communication links established with a base station and/or one or more neighboring terminals.

At 1210, the flowchart begins with the first terminal receiving, from a second terminal, configuration parameters for an SL localization procedure in which positioning information is obtained. The localization procedure may be an operation followed by the first terminal in coordination with one or more additional terminals. The additional terminals may be one or more UE devices or a combination of base stations and UE devices. In some embodiments, the first terminal may be a target terminal with an unknown absolute location on Earth on in a specific area (e.g., an area with known boundaries). In some embodiments, the first terminal may be configured to transmit a broadcasting signal to the second terminal. The broadcasting information may include terminal information and a communication request configured to trigger or request triggering of the SL localization procedure. The terminal information is information regarding one or more transmission and reception capabilities of the first terminal.

At 1220, the flowchart continues with the first terminal determining, based on the configuration parameters, a resource allocation pattern to be used in the SL transmission procedure. The resource allocation pattern is configured to include at least one SL-P(S) RS. As described above, a P(S) RS parameter or information element refers to a signal including the functionality of PRS, SRS, or a combination of both in the manner described in reference to FIGS. 9A-9D. The resource allocation pattern may be determined upon identifying reference information and synchronization information to be used in an SL transmission procedure to obtain the positioning information. The reference information may include communication information identifying at least one neighboring terminal to the first terminal as a positioning reference. The positioning reference may be a neighboring terminal that is configured to obtain its absolute location on Earth or on a specific area. The first terminal may implement the SL localization procedure upon receiving instructions from one of its neighboring terminals. The synchronization information may include communication information relating to allocation of resources for at least one synchronization signal. The terminals involved in an SL localization procedure using the SL transmissions may all share the same synchronization signal.

In 1221-1224, multiple dotted boxed include possible implementations of allocated resources in a resource pattern in which at least one SL-P(S) RS is used. At 1221-1224, the resource allocation pattern is implemented in accordance with the SL transmission procedure to obtain the absolute location of the first terminal in the manner described in reference to FIGS. 9A-9D. At 1221, the resource allocation pattern includes multiple SL-P(S) RS (e.g., reference signals) multiplexed between multiple unused resources. At 1222, the resource allocation pattern includes multiple SL-P(S) RS multiplexed between multiple resources configured for data transmission. At 1223, the resource allocation pattern includes multiple SL-P(S) RS multiplexed between unused resources in a data transmission bandwidth pair. At 1224, the resource allocation pattern includes multiple SL-P(S) RS multiplexed between unused resources in two data transmission bandwidth pairs.

The flowchart ends at 1230 with the first terminal obtaining the positioning information. The positioning information includes an absolute location of the target terminal. As described above, the positioning information may include the absolute location of the first terminal or a relative location of the first terminal with respect to the second terminal. If the first terminal determines its own absolute location, the first terminal may store its location. If the second terminal determines the absolute location of the first terminal, the first terminal obtains this information by receiving a communication from the second terminal.

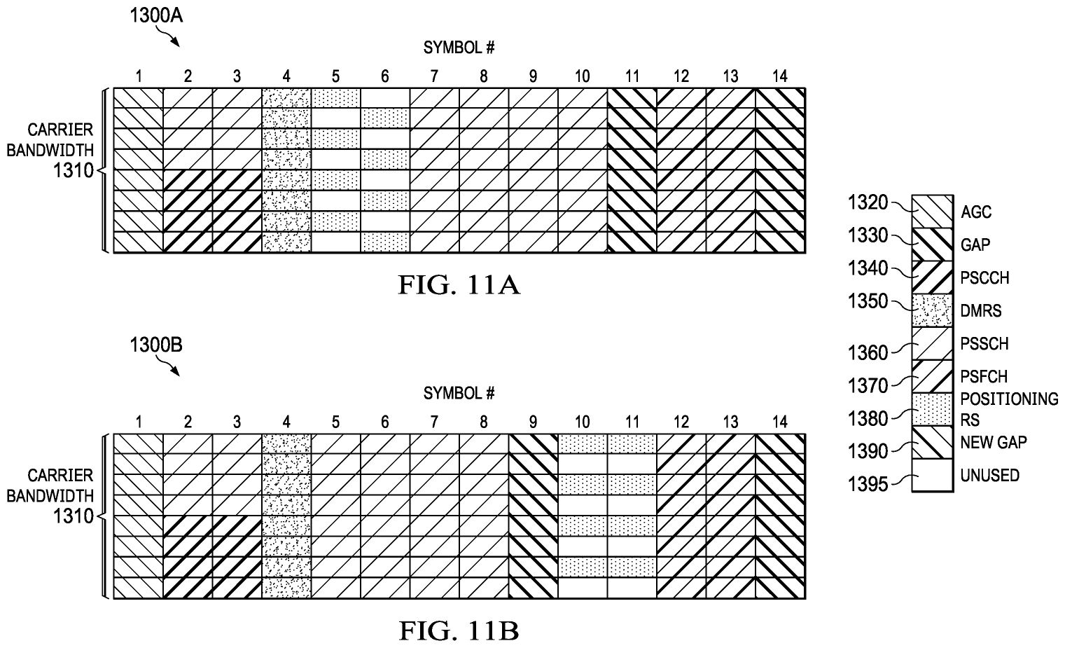

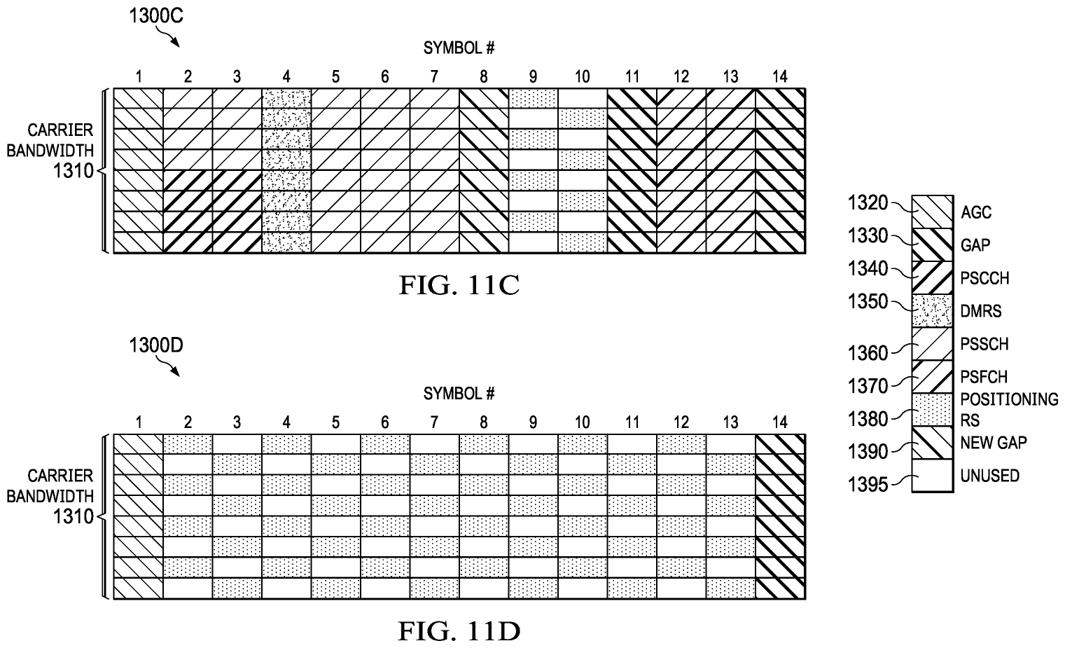

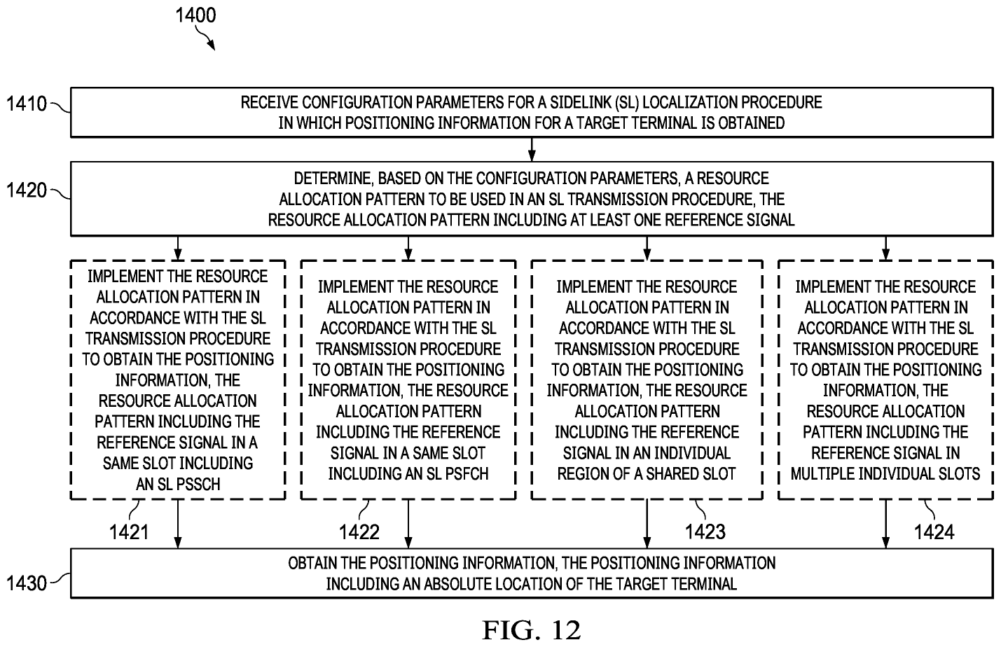

FIGS. 11A-11D illustrates diagrams 1300A-1300D showing slot structures in a radio frame configured for a resource allocation pattern, in accordance with aspects of the present disclosure. The diagrams 1300A-1300D show possible allocation locations for a reference signal. In the examples of FIGS. 11A-11D, slots are shown in a carrier bandwidth 1310. The carrier bandwidth 1310 includes an SL BWP expanding in a frequency domain in a vertical direction and a time domain in a horizontal direction. In the examples of FIGS. 11A-11D, the resources may be allocated for an AGC 1320, a GAP 1330, a PSCCH 1340, a DMRS 1350, a PSSCH 1360, a PSFCH 1370, a positioning RS 1380, and a new GAP 1390. The rest of resources may be unused resources 1195.

In the examples shown in FIGS. 11A-11D, a positioning reference signal may be chosen to leverage the UU link design. To this end, PRS/SRS may be used for SL positioning. In some embodiments, SL positioning is based on a DL-PRS as an SL-PRS. The SL positioning may be based on P-SRS as the SL-PSRS. In these scenarios, the UE device or target terminal implementing the resource allocation pattern may be configured based on terminal capability information. The terminal capability information may indicate that the UE device supports SL-PRS, SL-PSRS, or both SL-PRS and SL-PSRS. As described above, a joint signal including functionality from the SL-PRS, SL-PSRS, or both SL-PRS and SL-PSRS may be included in a SL-P(S) RS signal.

In the example of FIG. 11A, resources allocated for the positioning RS 1380 (e.g., the SL-P(S) RS) may be allocated in a same slot as the PSCCH 1340. In this case, the resource allocation pattern for the SL transmission includes the positioning RS 1380 in the PSSCH region (i.e., within the resources for the PSCCH 1340, after the PSCCH 1340, and before a first GAP 1330. In the example of FIG. 11B, the positioning RS 1380 may be allocated in a same slot as the PSFCH 1370. In this case, the resource allocation pattern for the SL transmission includes the positioning RS 1380 in the PSFCH region (i.e., within the resources for the PSFCH 1340, after a first GAP 1330, and before a second GAP 1330. In the example of FIG. 11C, the positioning RS 1380 may be allocated in dedicated positioning region in which the resources allocated for positioning RS 1380 are separated from other allocated resources via resources allocated for the new GAP 1390 and the GAP 1330. In this case, the resource allocation pattern for the SL transmission includes the positioning RS 1380 in its own dedicated slot with dedicated GAP symbols. The positioning RS 1380 may be allocated before the PSCH 1360, after the PSSCH 1360 and before the PSFCH 1370, or after the PSFCH 1370. In the example of FIG. 11D, the positioning RS 1380 may be allocated in an individual slot configured to only include resources for the positioning RS 1380, the AGC 1320, and the GAP 1330.

Turning to FIG. 16, a flowchart 1400 is shown, detailing a method of allocating resources in an SL radio frame to be used for an SL localization procedure in accordance with one or more embodiments. In this example, the method is executed by a first terminal exchanging information via SL communication links established with a base station and/or one or more neighboring terminals.

At 1410, the flowchart begins with the first terminal receiving, from a second terminal, configuration parameters for an SL localization procedure in which positioning information is obtained. The localization procedure may be an operation followed by the first terminal in coordination with one or more additional terminals. The additional terminals may be one or more UE devices or a combination of base stations and UE devices. In some embodiments, the first terminal may be a target terminal with an unknown absolute location on Earth on in a specific area (e.g., an area with known boundaries). In some embodiments, the first terminal may be configured to transmit a broadcasting signal to the second terminal. The broadcasting information may include terminal information and a communication request configured to trigger or request triggering of the SL localization procedure. The terminal information is information regarding one or more transmission and reception capabilities of the first terminal.

At 1420, the flowchart continues with the first terminal determining, based on the configuration parameters, a resource allocation pattern to be used in the SL transmission procedure. The resource allocation pattern is configured with at least one reference signal. The reference signal is used to provide multiple terminals with a baseline transmission information that these terminals may identifying on SL transmissions exchanged with one other. As described above, reference signals are predefined signals occupying specific resource elements within a communication time-frequency grid. In the NR specification, multiple types of reference signals may be transmitted in different ways and intended to be used for different purposes by a receiving device. In this disclosure, the reference signals are modified for implementation in SL transmissions.

In some embodiments, the localization information is obtained by evaluating SL transmissions to (or from) a target terminal based on 2 or more neighboring terminals in a positioning set. The positioning set is a group of terminals used to perform localization procedures. The positioning set may be preconfigured before the localization procedure starts or it may be set dynamically. The positioning set may include two terminals for two-dimensional (2-D) positioning and three terminals for three-dimensional (3-D) positioning. The localization procedure may be suitable to identify positioning information relating to target terminals that are out of coverage, in partial coverage, and in complete coverage scenarios.

The resource allocation pattern may be determined upon identifying reference information and synchronization information to be used in an SL transmission procedure to obtain the positioning information. The reference information may include communication information identifying at least one neighboring terminal to the first terminal as a positioning reference. The positioning reference may be a neighboring terminal that is configured to obtain its absolute location on Earth or on a specific area. The first terminal may implement the SL localization procedure upon receiving instructions from one of its neighboring terminals. The synchronization information may include communication information relating to allocation of resources for at least one synchronization signal. The terminals involved in an SL localization procedure using the SL transmissions may all share the same synchronization signal.

In 1421-1424, multiple dotted boxed include possible implementations of allocated resources in a resource pattern in which at least one reference signal is used. At 1421-1424, the resource allocation pattern is implemented in accordance with the SL transmission procedure to obtain the absolute location of the first terminal in the manner described in reference to FIGS. 11A-11D. At 1421, the resource allocation pattern includes the reference signal in a same slot including an SL PSSCH. At 1422, the resource allocation pattern includes the reference signal in a same slot including an SL PSFCH. At 1423, the resource allocation pattern includes the reference signal in an individual region of a shared slot. In this case, while the slot includes resources allocated to multiple signals, the resources allocated for the reference signal are separated from the other resources using gaps. At 1424, the resource allocation pattern includes the reference signal in multiple individual slots. In this case, most of the radio frame is configured to only include the reference signal.

The flowchart ends at 1430 with the first terminal obtaining the positioning information. The positioning information includes an absolute location of the target terminal. As described above, the positioning information may include the absolute location of the first terminal or a relative location of the first terminal with respect to the second terminal. If the first terminal determines its own absolute location, the first terminal may store its location. If the second terminal determines the absolute location of the first terminal, the first terminal obtains this information by receiving a communication from the second terminal.

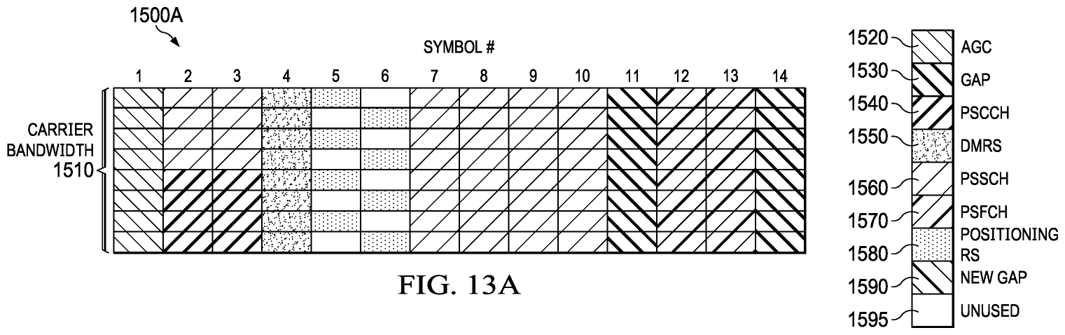

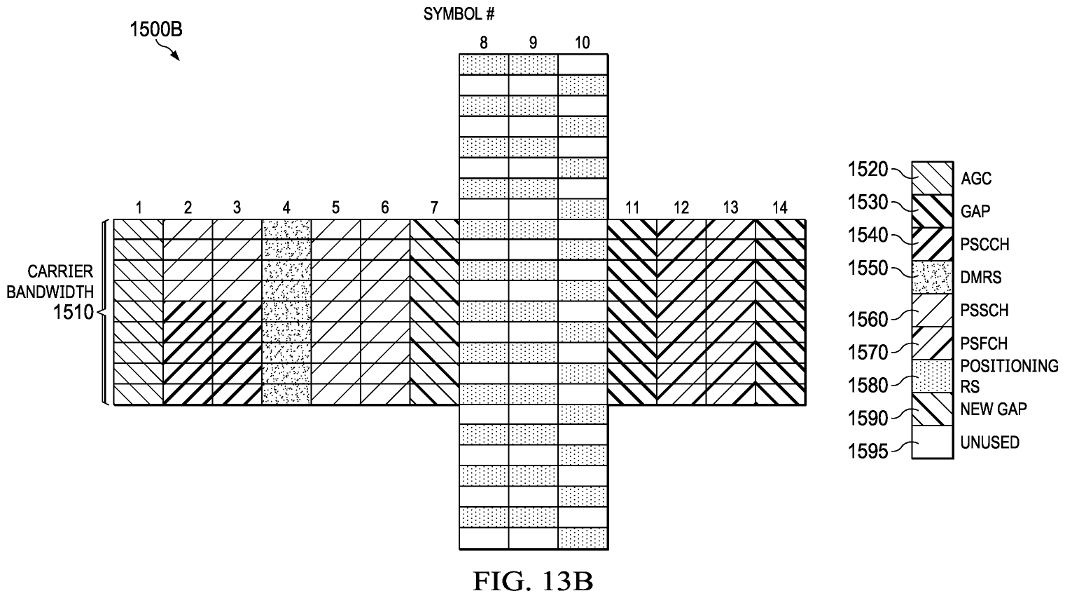

FIGS. 13A and 13B illustrates diagrams 1500A and 1500B showing slot structure in a radio frame configured for a resource allocation pattern, in accordance with aspects of the present disclosure. The diagrams 1500A and 1500B show possible sizes of a reference signal in the frequency domain. In the examples of FIGS. 13A and 13B, slots are shown in a carrier bandwidth 1510. The carrier bandwidth 1510 includes an SL BWP expanding in a frequency domain in a vertical direction and a time domain in a horizontal direction. In the examples of FIGS. 13A and 13B, the resources may be allocated for an AGC 1520, a GAP 1530, a PSCCH 1540, a DMRS 1550, a PSSCH 1560, a PSFCH 1570, a positioning RS 1580, and a new GAP 1590. The rest of resources may be unused resources 1595.

FIGS. 13A and 13B show interactions between the positioning RS 1580 and multiple allocated signals. In cases where the positioning RS 1580 is allocated to a resource already containing the DMRS 1150. In these cases, the allocation may be skipped if a collision is identified. Further, if the positioning RS 1580 is an SL-P(S) RS configured to include functionality for an SL-PRS, no performance impact occurs to the resources allocated for the DMRS 1150 as the design may be identical. Thus, no changes may be made. If the positioning RS 1580 is the SL-P(S) RS configured to include functionality for an SL-PSRS, the SL-PRS may be prioritized. The terminal implementing the resource allocation pattern may not expect to be configured with aperiodic SL-P(S) RS signals that collides with the DMRS 1150.

In cases where the positioning RS 1580 is allocated to a resource already containing an S-SSB, the positioning RS 1580 may be skipped. In cases where the positioning RS 1580 is allocated to a resource already containing the PSCCH 1140, the positioning RS 1580 may be skipped. In this case, the terminal may allocate the positioning RS 1580 in resources in the frequency domain. In cases where the positioning RS 1580 is allocated to a resource already containing a PTRS, the PTRS may be skipped. Further, the PTRS may be allocated at a next available slot. Depending on a pre-configuration, the PTRS may be prioritized, and the positioning RS 1580 may be skipped.

In one or more embodiments, resources may be additionally allocated in the frequency domain. In NR V2X, a resource pool may be divided into a pre-configured number of sub-channels, where a sub-channel is a group of consecutive PRBs in a slot. Possible sizes of the group may be 10, 12, 15, 20, 25, 50, 75 or 100 PRBs.

In the example of FIG. 13A, resources allocated for the positional RS 1580 (e.g., the SL-P(S) RS) may be allocated along the frequency domain to match a size of the PSSCH sub-channel. In this case, the positional RS 1580 may be transmitted anywhere within the PSSCH 1560 in accordance with one or more configuration parameters.

In the example of FIG. 13B, resources allocated for the positional RS 1580 may be allocated along the frequency domain to exceed the size of the PSSCH 1560. In this case, the positional RS 1580 may be transmitted before or after the PSSCH 1560 and not in the middle of the PSSCH 1560 to limit effects of change in power. In this case, the positional RS 1580 may add the new GAP 1590 between the PSSCH 1560 and the positional RS 1580. Further, this scenario may use an independent sensing mechanism including an extra symbol for the AGC 1520 before at the start of the positional RS 1580. In some embodiments the positional RS 1580 may be allocated along the frequency domain to be less than the size of the PSSCH 1560. In either case, the different size may be configured semi-statically or dynamically as indicated by one or more configuration parameters.

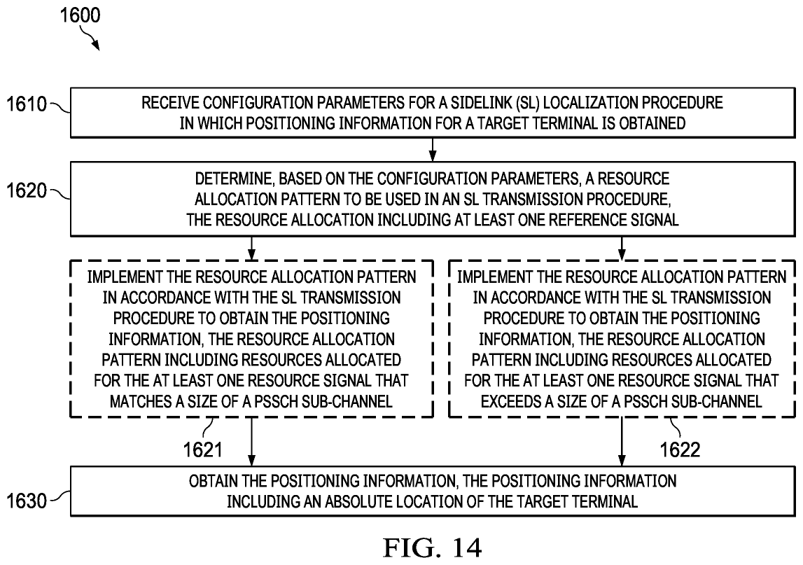

Turning to FIG. 14, a flowchart 1600 is shown, detailing a method of allocating resources in an SL radio frame to be used for an SL localization procedure in accordance with one or more embodiments. In this example, the method is executed by a first terminal exchanging information via SL communication links established with a base station and/or one or more neighboring terminals.

At 1610, the flowchart begins with the first terminal receiving, from a second terminal, configuration parameters for an SL localization procedure in which positioning information is obtained. The localization procedure may be an operation followed by the first terminal in coordination with one or more additional terminals. The additional terminals may be one or more UE devices or a combination of base stations and UE devices. In some embodiments, the first terminal may be a target terminal with an unknown absolute location on Earth on in a specific area (e.g., an area with known boundaries). In some embodiments, the first terminal may be configured to transmit a broadcasting signal to the second terminal. The broadcasting information may include terminal information and a communication request configured to trigger or request triggering of the SL localization procedure. The terminal information is information regarding one or more transmission and reception capabilities of the first terminal.

At 1620, the flowchart continues with the first terminal determining, based on the configuration parameters, a resource allocation pattern to be used in the SL transmission procedure. The resource allocation pattern is configured to include at least one reference signal. The resource allocation pattern is configured with at least one reference signal. The reference signal is used to provide multiple terminals with a baseline transmission information that these terminals may identifying on SL transmissions exchanged with one other. As described above, reference signals are predefined signals occupying specific resource elements within a communication time-frequency grid. In the NR specification, multiple types of reference signals may be transmitted in different ways and intended to be used for different purposes by a receiving device. In this disclosure, the reference signals are modified for implementation in SL transmissions.

In 1621 and 1622, multiple dotted boxed include possible implementations of allocated resources in a resource pattern in which at least one reference signal is used. At 1621 and 1622, the resource allocation pattern is implemented in accordance with the SL transmission procedure to obtain the absolute location of the first terminal in the manner described in reference to FIGS. 13A and 13B. At 1621, the resource allocation pattern includes resources allocated for the resource signal that matches a size of a PSSCH sub-channel. At 1622, the resource allocation pattern includes resources allocated for the resource signal that exceeds a size of a PSSCH sub-channel.

The flowchart ends at 1630 with the first terminal obtaining the positioning information. The positioning information includes an absolute location of the target terminal. As described above, the positioning information may include the absolute location of the first terminal or a relative location of the first terminal with respect to the second terminal. If the first terminal determines its own absolute location, the first terminal may store its location. If the second terminal determines the absolute location of the first terminal, the first terminal obtains this information by receiving a communication from the second terminal.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102, a network element 600) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A first terminal, comprising:
a receiver that receives, from a second terminal, configuration parameters for a Sidelink (SL) localization procedure in which positioning information of the first terminal is obtained; and
a processor configured to:
determine, based on the configuration parameters, a resource allocation pattern to be used in an SL transmission procedure, and
implement the resource allocation pattern in accordance with the SL transmission procedure to obtain the positioning information.

2. The first terminal of claim 1, further comprising:
a transmitter that transmits a broadcasting signal to the second terminal, the broadcasting signal including terminal information and a communication request,
wherein the terminal information is information regarding one or more transmission and reception capabilities of the first terminal, and
wherein the communication request is signaling requesting a start of the localization procedure.

3. The first terminal of claim 1, wherein:
the processor is further configured to:
identify an SL resources pool including a set of SL resources for communicating directly with the second terminal,
determine the resource allocation pattern based on the SL resources pool identified, the resource allocation pattern allocating resources to at least a portion of the set of SL resources in the SL resources pool, and
determine the positioning information after the resource allocation pattern is implemented, the positioning information including an absolute location of the first terminal or a relative location of the first terminal with respect to the second terminal.

4. The first terminal of claim 3, wherein the SL resources pool is an existing SL resources pool previously configured for the SL transmission.

5. The first terminal of claim 3, wherein the SL resources pool is an independent SL resources pool selected for the SL localization procedure.

6. The first terminal of claim 1, wherein the processor is further configured to:
identify, based on the configuration parameters, an SL reference signal that is used in the Sidelink (SL) localization procedure to obtain the positioning information, and
determine the resource allocation pattern based on the SL reference signal identified, the resource allocation pattern allocating resources to include the SL reference signal.

7. The first terminal of claim 6, wherein the SL reference signal is:
an SL-Positioning Reference Signal (PRS) configured to be implemented in a first resource allocation pattern,
an SL-Positioning Sounding Reference Signal (PSRS) configured to be implemented in a second resource allocation pattern, or
an SL-joint PRS/PSRS (P(S) RS) configured to be implemented in the first resource allocation pattern, the second resource allocation pattern, or a combination of the first resource allocation pattern and the second resource allocation pattern based on terminal information of the first terminal.

8. The first terminal of claim 6, wherein the resource allocation pattern includes the SL reference signal allocated:
in a first slot in which resources for a Physical Sidelink Shared Channel (PSSCH) are allocated,
in a second slot in which resources for a Physical Sidelink Feedback Channel (PSFCH) are allocated, or
in a third slot in which channel resources are not allocated.

9. The first terminal of claim 6, wherein the processor is further configured to:
implement a first collision protocol when resources allocated for the SL reference signal interact with resources allocated for a Demodulation Reference Signal (DMRS) in the resource allocation pattern,
implement a second collision protocol when resources allocated for the SL reference signal interact with resources allocated for a Physical Sidelink Control Chanel (PSCCH) in the resource allocation pattern, and
implement a third collision protocol when resources allocated for the SL reference signal interact with resources allocated for a Phase Tracking Reference Signal (PT-RS) in the resource allocation pattern.

10. The first terminal of claim 6, wherein the processor is further configured to implement the resource allocation pattern in a specific sub-channel based on the configuration parameters, a specific sub-channel size being equal or greater than a Physical Sidelink Shared Channel (PSSCH) sub-channel size.

11. The first terminal of claim 6, wherein the resource allocation pattern includes:
in a first slot in which a plurality of resources allocated for the SL reference signal are interposed with a plurality of unused resources, or
in a second slot in which the plurality of resources allocated for the SL reference signal are interposed with a plurality of resources allocated for a Physical Sidelink Shared Channel (PSSCH).

12. (canceled)

13. (canceled)

14. (canceled)

15. (canceled)

16. (canceled)

17. (canceled)

18. A method, comprising:
receiving, at a first terminal and from a second terminal, configuration parameters for a Sidelink (SL) localization procedure in which positioning information of the first terminal is obtained;
determining, at the first terminal and based on the configuration parameters, a resource allocation pattern to be used in an SL transmission procedure, and
implementing, at the first terminal, the resource allocation pattern in accordance with the SL transmission procedure to obtain the positioning information.

19. The method of claim 18, further comprising:
transmitting, from the first terminal, a broadcasting signal to the second terminal, the broadcasting signal including terminal information and a communication request,
wherein the terminal information is information regarding one or more transmission and reception capabilities of the first terminal, and
wherein the communication request is signaling requesting a start of the localization procedure.

20. The method of claim 18, further comprising:
identifying, at the first terminal, an SL resources pool including a set of SL resources for communicating directly with the second terminal;
determining, at the first terminal, the resource allocation pattern based on the SL resources pool identified, wherein the resource allocation pattern allocates resources to at least a portion of the set of SL resources in the SL resources pool; and
determining, at the first terminal, the positioning information after the resource allocation pattern is implemented, wherein the positioning information includes an absolute location of the first terminal or a relative location of the first terminal with respect to the second terminal.

21. The method of claim 20, wherein the SL resources pool is an existing SL resources pool previously configured for the SL transmission.

22. The method of claim 20, wherein the SL resources pool is an independent SL resources pool selected for the SL localization procedure.

23. An integrated circuit configured to cause a first terminal to:
receive, from a second terminal, configuration parameters for a Sidelink (SL) localization procedure in which positioning information of the first terminal is obtained;
determine, based on the configuration parameters, a resource allocation pattern to be used in an SL transmission procedure, and
implement the resource allocation pattern in accordance with the SL transmission procedure to obtain the positioning information.

24. The integrated circuit of claim 23, wherein the integrated circuit is further configured to cause the first terminal to:
identify, based on the configuration parameters, an SL reference signal that is used in the Sidelink (SL) localization procedure to obtain the positioning information, and
determine the resource allocation pattern based on the SL reference signal identified, wherein the resource allocation pattern allocates resources to include the SL reference signal.

25. The integrated circuit of claim 24, wherein the SL reference signal is:
an SL-Positioning Reference Signal (PRS) configured to be implemented in a first resource allocation pattern,
an SL-Positioning Sounding Reference Signal (PSRS) configured to be implemented in a second resource allocation pattern, or
an SL-joint PRS/PSRS (P(S) RS) configured to be implemented in the first resource allocation pattern, the second resource allocation pattern, or a combination of the first resource allocation pattern and the second resource allocation pattern, based on terminal information of the first terminal.

26. The integrated circuit of claim 24, wherein the resource allocation pattern includes the SL reference signal allocated:
in a first slot in which resources for a Physical Sidelink Shared Channel (PSSCH) are allocated,
in a second slot in which resources for a Physical Sidelink Feedback Channel (PSFCH) are allocated, or
in a third slot in which channel resources are not allocated.
